(19) United States
(12) Patent Application Publication
(10) Pub. No.: US 2019/0313630 A1
(43) Pub. Date: Oct. 17, 2019

(54) METHOD AND DEVICE FOR INFLUENCING INSECTS

(71) Applicant: Nopixglobal AG, Kloten (CH)

(72) Inventor: Kurt STOLL, Glattbrugg (CH)

(21) Appl. No.: 16/466,954

(22) PCT Filed: Nov. 30, 2017
(86) PCT No.: PCT/EP2017/080917

§ 371 Date: Jun. 5, 2019

(30) Foreign Application Priority Data
Dec. 6, 2016 (CH) 01606/16

(51) Int. Cl. A01M 29/28; H04B 1/04

(52) U.S. Cl. CPC A01M 29/28; H04B 1/04

(57) ABSTRACT

In a method and device for influencing insects by means of electromagnetic radiation, a transmitter generates a time-based progression of an antenna feed with pulses, which is emitted via an antenna as electromagnetic radiation having corresponding pulses. The antenna feed comprises bursts, or packets or salvoes, of pulses, wherein the time interval between directly successive pulses of a burst is in the range from 5 με to 9 με and the time expansion of the burst is at least 0.1 ms. Because of the intensity gradients that arise in a radial direction around an antenna, a movement leading towards the antenna is, for insects, directly associated with an increase in perception intensity and a movement leading away is associated with a decrease. The insects perceive the gradient and tend to move such that the irritating perception decreases for them.

The invention relates to a method according to the preamble of claim 1 and a device according to the preamble of claim 7 and a computer program product which causes a method according to the preamble of claim 1 to be performed on a program-controlled device.

The present invention relates in particular to methods and devices for influencing mosquitoes, preferably for reducing their biting activity.

Various solutions are available to reduce the bite activity of mosquitoes, such as insecticides, physical protective devices such as mosquito nets, repellents to be applied to the skin or clothing, and devices that attract mosquitoes to traps or repel them from areas.

WO 99/55151 A1 describes a device which generates oscillations with two electrical oscillators, each of which is transmitted via a contact plate to the skin of a person protecting himself with it. The two separate oscillations are transmitted to the skin surface with 1.2 KHz and 64.0 KHz and a maximum power density of 1 mW/cm2 and emitted to mosquitoes contacting the skin. In the case of mosquitoes landing on the skin, the superimposed surface waves coming from the oscillators are supposed to cause a disturbance and to then entice said mosquitoes to leave the skin surface. If the mosquitoes bite immediately after landing or if the transmission of the oscillations to the skin surface is insufficient, the effect against bites is not good enough.

WO 2012/094768 A1 describes a device comprising two microprocessors and two transmitters. A stored pulse shape is modulated with a carrier frequency of 565 KHz and radiated in the form of electromagnetic waves via the two transmitters and the antennas coupled to each of them. With transmission powers of 5 μW or 1 mW, the two interacting transmitters are intended to protect people within a radius of 2 m or 15 m from mosquitoes. Tests have shown that the protection is not good enough.

WO 2016/165035 A1 describes a dual-channel transmitter with two magnetic antennas. The dual-channel transmitter includes a microprocessor that generates a pulse train signal with a pulse width of 204 ms and a pulse pause of 5000 ms. The pulse consists of three partial pulses of 12 ms pulse width and two short pauses of 84 ms between the partial pulses. Two signals are generated from the pulse sequence signal, one with positive and one with negative values. Both signals are modulated with a modulation frequency of 284 Hz and are phase-shifted by 180 degrees against each other over time. The two modulated and phase-shifted pulse sequence signals are each fed to a transmitter, which supplies the signals with a carrier frequency of 160 kHz and a transmission power of 2 mW each to a magnetic antenna. The modulation of the two pulse sequence signals with a modulation frequency and the subsequent generation of transmission signals with a carrier frequency deviating from the modulation frequency is complex. In addition, relatively high currents must be provided for the two magnetic antennas even at low transmission power levels.

The object according to the invention now consists of finding a simple solution that influences insects within a sufficiently large area with as little effort as possible.

The object is solved by a method with the features of claim 1, a device with the features of claim 7 and a computer program product with the features of claim 13. The dependent claims describe alternative or advantageous embodiment variants that solve further objects.

In a method according to the invention or a device according to the invention for influencing insects by means of electromagnetic radiation, a transmitter generates a time-based progression of an antenna supply with pulses and emits it via an antenna as electromagnetic radiation with corresponding pulses. The antenna supply comprises bursts, or packets or salvoes, of pulses, wherein the time interval between directly successive pulses of a burst is in the range from 5 μs to 9 μs and the time extension of the burst is at least 0.1 ms, preferably at least 1 ms, in particular in the range from 1 to 4 ms, or optionally at least 3 ms.

In solving the object, it was recognized that it is important for the influence of electromagnetic radiation on insects that the radiation includes bursts, or packets or salvoes, of short-term pulses. In the case of the emitted short-term pulses of the bursts, the time interval between directly successive burst pulses must be in the range from 5 ps to 9 μs, preferably in the range from 5.8 μs to 7.7 μs, especially in the range from 6.0 μs to 7.3 μs. The pulses can be formed as positive or negative pulses, wherein the pulses of a burst are of the same type, i.e. either positive or negative and essentially with the same pulse height. For the pulses to affect the insects, each burst must include a minimum number of pulses. To amplify the influence, the number of pulses of a burst and/or the number of bursts emitted in short time intervals can be increased. To avoid unnecessarily high energy consumption, the number of pulses per burst and the number of bursts per time are not selected higher than is necessary for the desired influence.

The time extension of the burst results from the number of pulses of a burst and the respective time interval between directly successive pulses. When determining the number of pulses per burst or the time extension of a burst, it must be ensured that a sufficient number of effective pulses is available, depending on the controller used or on the components of the circuit, i.e. also, for example, during transient and/or decay processes or for slow components. Preferably, a predetermined portion of the pulses of a burst reaches a given pulse height. Tests have shown that it is necessary that the time extension of each burst is at least 0.1 ms, if necessary at least 3 ms, but preferably in the range from 1 ms to 16 ms, in particular in the range from 1 ms to 4 ms, wherein good results are achieved with 2 ms. A burst of 2 ms time extension would, for example, then comprise 300 pulses with intervals of 6.7 μs. Experiments have shown that this theoretical pulse rate per burst produces very good results in mosquitoes, even if pulses at the beginning or end of the bursts are not effective.

Tests have also shown that it is advantageous if the time intervals between bursts directly following each other in short intervals are at least 50 ms and preferably in the range of 70 ms to 100 ms. The number of bursts directly following each other in short intervals should be at least three, but preferably in the range of three to ten, especially four. The time interval between directly successive series of bursts at short intervals should be at least 1 s, but preferably in the range from 1 s to 3 s, especially at 2 s. Preferably, all pulses of a burst, in particular at least one series of bursts following one another at short intervals, are of the same positive or negative nature. In order to avoid a possibly restrictive dominant alignment of the pulses, the pulses of individual series are aligned positively and the pulses of other series negatively in a special embodiment, preferably alternating from series to series.

Only one antenna and only one transmitter are needed or used in order to be able to radiate the short-term pulses necessary for influencing the insects with little effort in such a way that they have an intensity required for influencing them in a close range enveloping a human being. Preferably, an antenna in the form of an air-core coil is used. An antenna integrated in the printed circuit board is advantageous. When using only one antenna and especially when using an air-core coil, which is known to have a low inductance, the necessary influence of insects in a close range enveloping a human being can be achieved even with low electrical power. The radiation intensity can be set so low that harmful effects in humans cannot be observed, which is essentially the case even for electrosensitive persons.

The method according to the invention can be carried out with a device which has only small power consumption and can therefore be fed, for example, by a standard battery or a standard rechargeable battery. The device can be designed as a pendant, wrist-band or even as a device that is carried in a piece of clothing, for example. Optionally, a computer program product will enable a device to perform the method in accordance with the invention.

It has been recognized that for the desired protective effect the affected insects do not have to be impaired in their functions, but that they avoid this area due to the perception of the extremely short-term pulses in an area adapted to a human being. Due to the intensity gradients originating around an antenna in the radial direction, a movement leading to the antenna is directly associated by the insects with an increase in the intensity of perception and a movement leading away with a decrease. The insects perceive the gradient and tend to move in such a way that the irritating perception decreases for them.

In order to ensure that the carrying of a device for influencing insects will not cause disturbance, this device is built as small as possible and is worn, for example, as a wristband. Such a wristband comprises a stable and waterproof electronic housing and, for example, a charging socket or a photovoltaic charging element, as well as display and, where appropriate, on/off elements or input elements.

The electronics or circuit with antenna is constructed as a complete module from as few modules as possible. For example, a microcontroller can supply a transmitter with the necessary control signal. The transmitter preferably generates a modulated signal, in particular by means of amplitude modulation, using a carrier frequency in the range from 10 MHz to 24 GHz, in particular from 300 to 450 MHz, wherein 433 MHz is particularly suitable in terms of radius of action and energy requirement. The output stage of the transmitter comprises a transistor which supplies the antenna signal to the antenna via its collector output. The operating voltage, for example, is supplied by a Li-polymer battery, which includes protection and monitoring electronics. To charge the battery, a connector, for example a Micro-USB socket 8, and a charging chip are used, wherein the charging chip monitors the battery voltage during the charging process and switches off the charging process when full charge is reached. LEDs provide information about the operating status and the battery. A voltage stabilizer is inserted between the battery and the microcontroller as well as the transmitter and one side of the antenna.

As an advantageous antenna, for example, an air-core coil with at least 40, in particular 85 windings is used, wherein the windings are arranged in a rectangular form around a coil axis. Preferably, the antenna is integrated in the print and has for example an internal resistance in the range of 0.05 to 0.3 ohms. The rectangular side lengths are adapted to the dimensions of the electronics housing or to the peripheral edge of a printed circuit board with the electronics and lie in the range from 10 mm to 30 mm, for example 17.3 mm and 26.0 mm. The copper wire used for the air-core coil, for example, has a diameter in the range from 0.04 to 0.08 mm, especially 0.06 mm, and an internal resistance of 11 to 30 ohms, especially 16 ohms. One end of the air-core coil is connected to the output stage of the transmitter and the other end to a stabilized system voltage of the voltage stabilizer. The transmission power measured at the collector of the transistor is −2.286 dBm/0.5907 mW so that an effective electromagnetic field is generated in a range of approx. 4 m around the wristband.

In order to reduce possible interfering influences of the electromagnetic radiation emitted by the antenna on the electronics or circuit, the electronics can be arranged in a metallic, mass-forming housing. It is preferable to arrange the antenna at a minimum distance therefrom so that the electromagnetic radiation can propagate unhindered. In the case of a wristband, for example, a metallic housing with the electronics and the antenna are arranged offset from each other in the circumferential direction of the wristband. If electronic assemblies or components, such as the microcontroller, the transmitter and the voltage stabilizer, or elements of these assemblies, such as an oscillator, a driver or an amplifier, and lines between these elements must be shielded from each other and/or from the antenna, these can be placed in areas of the metallic housing separated by metallic walls. The supply voltage supplied by the battery is protected by capacitors against high-frequency influences emanating from the antenna and/or the electronics, if necessary.

The drawings explain the invention using an embodiment example to which it is not restricted, wherein:

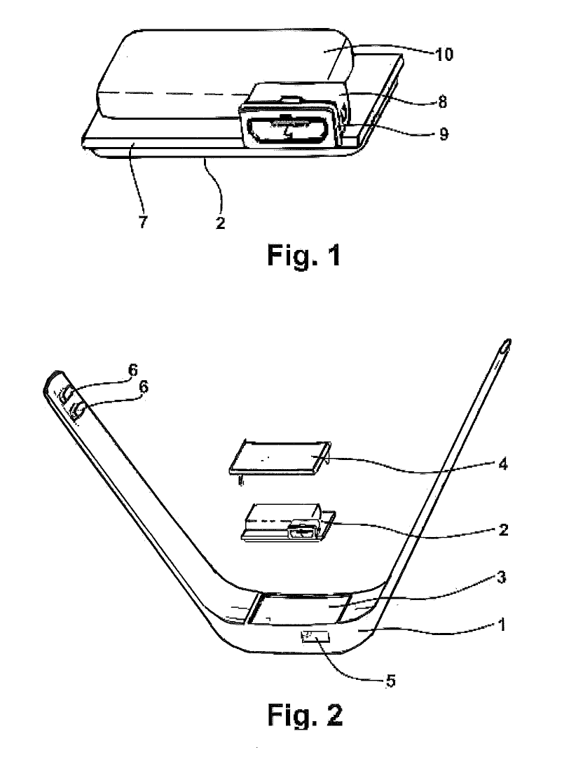

FIG. 1 shows a perspective representation of a transmitter module,

FIG. 2 shows a perspective exploded view of a wristband with transmitter module and cover,

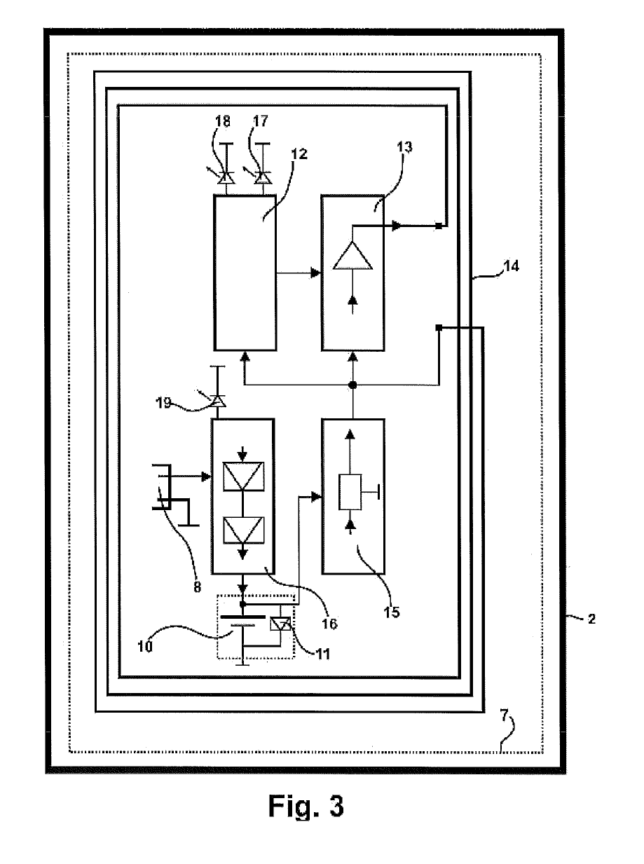

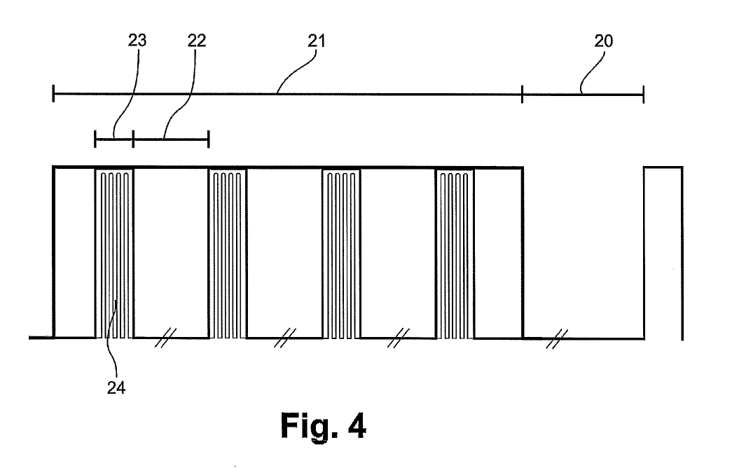

FIG. 3 shows a schematic representation of the transmitter module structure and,

FIG. 4 shows an example of a time-based progression of the antenna signal.

FIG. 1 shows a transmitter module 2 for a wristband 1 shown in FIG. 2. The transmitter module 2 is arranged on a printed circuit board 7 and comprises a battery 10 which can be supplied via a socket 8. To allow the socket 8 to be inserted tightly into a socket opening 5 of the wristband 1, the socket 8 comprises a sealing element 9. According to FIG. 2, the transmitter module 2 is inserted into a housing 3 of the wristband 1 and the socket 8 is pressed tightly into the socket opening 5. The housing 3 is then sealed tightly with a cover 4. Wristband 1 has closure elements 6.

FIG. 3 shows the schematic structure of the transmitter module 2, which is arranged on the printed circuit board 7. The transmitter module 2 comprises a microcontroller 12, which supplies the necessary control signal to a transmitter 13. The transmitter 13 preferably generates a modulated signal, in particular by means of amplitude modulation, using a carrier frequency in the range from 10 MHz to 24 GHz, in particular from 300 to 450 MHz, wherein 433 MHz is particularly suitable in terms of radius of action and energy requirement. The output stage of the transmitter 13 comprises a transistor which supplies the antenna signal to an antenna 14 via its collector output. The operating voltage is supplied by a Li-Polymer battery 10, which includes protection and monitoring electronics 11. For charging the battery 10, socket 8 and a charging chip 16 are used, wherein the charging chip 16 monitors the battery voltage during the charging process and switches off the charging process when full charge is reached. LEDs 17, 18 and 19 provide information on the operating status and the battery. A voltage stabilizer 15 is inserted between the battery 10 and the microcontroller 12 as well as the transmitter 13 and one side of the antenna 14.

The antenna 14 is designed as an air-core coil with 85 turns, wherein the turns are arranged in a rectangular form around a coil axis. The rectangular side lengths are adapted to the dimensions of the electronics housing or to the circumferential edge of a printed circuit board 7 and are, for example, 17.3 mm and 26.0 mm. The copper wire used for the air-core coil, for example, has a diameter of 0.06 mm and an internal resistance of 23.6 ohms. One end of the air-core coil or the loop antenna integrated in the print is connected to the output stage of the transmitter 13 and the other end to a stabilized system voltage of the voltage stabilizer 15.

FIG. 4 schematically shows an example of a time-based progression of the antenna signal with bursts 23, or packets or salvoes, each comprising short pulses 24. For the pulses 24 of each burst 23, the time interval between consecutive pulses 24 is in the range of 5 μs to 9 μs, preferably in the range of 5.8 μs to 7.7 μs, especially in the range of 6.0 μs to 7.3 μs. The pulses 24 in the embodiment shown are designed as positive pulses 24. The pulses 24 of a burst 23 are of the same type and have essentially the same pulse height. For the pulses 24 to affect insects, each burst 23 must include a minimum number of pulses of 24. In order to amplify the influence, the number of pulses 24 of a burst 23 and/or the number of bursts 23 emitted in short time intervals can be increased.

The number of pulses 24 of a burst 23 and the respective time interval between directly successive pulses 24 give the time extension of the burst 23. Experiments have shown that it is advantageous if the time extension of each burst 23 is at least 0.1 ms, optionally at least 3 ms, but preferably in the range from 1 ms to 16 ms, in particular in the range from 1 ms to 4 ms, with good results being achieved with 2 ms. Bursts 23 of 2 ms time extension with pulses 24 with intervals of 6.7 μs show very good results with mosquitoes. In the embodiment shown, the short time intervals 22 between successive bursts 23 are at least 50 ms, preferably in the range of 70 ms to 100 ms. The number of bursts 23 in short intervals should be at least two, especially at least three. In the embodiment shown, this number is four. The large time interval 20 between successive series of bursts 23 consecutive at short intervals is at least 1 s, preferably in the range from 1 s to 3 s, in particular at 2 s. The time extension 21 corresponds to the time taken to provide a number of bursts 21 at shorter intervals in succession.

1. A method for influencing insects by means of electromagnetic radiation, in which method a time-based course of an antenna supply with pulses is generated by a transmitter and is radiated via an antenna as electromagnetic radiation with corresponding pulses, wherein the antenna supply comprises bursts, or packets or salvoes, of pulses, wherein the time interval between directly successive pulses of a burst is in the range from 5 μs to 9 μs and the time extension of the bursts is at least 0.1 ms.

2. The method according to claim 1, wherein the time extension of the bursts is at least 1 ms, and preferably lies in the range from 1 to 4 ms, in particular 2 ms.

3. The method according to claim 1, wherein the time extension of the burst is at least 3 ms.

4. The method according to claims 1, wherein the time intervals between bursts following one another at short intervals are at least 50 ms and preferably lie in the range from 70 ms to 100 ms.

5. The method according to claim 1, wherein the number of bursts following one another at short intervals is at least three, but preferably in the range of three to ten, in particular four.

6. The method according to claim 1, wherein the time interval between successive series of bursts following one another at short intervals is at least 1 s, but preferably in the range from 1 s to 3 s, in particular 2 s.

7. The method according to claim 1, wherein all pulses of a burst, preferably also all pulses of a series of bursts following one another at short intervals, are formed of the same positive or negative type and preferably a predetermined proportion of the pulses of a burst reaches a predetermined pulse height.

8. The method according to claim 1, wherein the transmitter generates a modulated signal, preferably by means of amplitude modulation, using a carrier frequency in the range from 10 MHz to 24 GHz, preferably from 300 to 450 MHz, in particular from 433 MHz.

9. A device for influencing insects by means of electromagnetic radiation, having a transmitter and an antenna, wherein the transmitter is able to generate a time-based progression of an antenna supply with pulses and to radiate this via the antenna as electromagnetic radiation with corresponding pulses, wherein the transmitter uses bursts, or packets or salvoes, of pulses, such that the time interval between directly successive pulses of a burst is in the range from 5μs to9 μs, and the time extension of the burst is at least 0.1 ms, preferably at least 1 ms, optionally at least 3 ms.

10. The device according to claim 9, wherein the antenna is integrated in the print or is designed in the form of an air-core coil which preferably consists of a copper wire with a diameter in the range from 0.04 to 0.08 mm and an internal resistance of 20 to 30 ohms and wherein the air-core coil comprises, for example, at least 40, in particular 85, turns which are optionally formed in a rectangular shape, in particular with side lengths in the range from 10 mm to 30 mm.

11. The device according to claim 9, wherein the device comprises a microcontroller which makes a control signal supplyable to the transmitter, wherein the transmitter preferably generates a modulated signal, in particular by means of amplitude modulation, using a carrier frequency in the range from 10 MHz to 24 GHz, preferably from 300 to 450 MHz, in particular from 433 MHz.

12. The device according to claim 9, wherein the transmitter makes the antenna supply producible in such a way that the time intervals between bursts following one another at short intervals are at least 50 ms and preferably lie in the range from 70 ms to 100 ms.

13. The device according to claim 7, wherein the transmitter makes the antenna supply producible in such a way that the number of bursts following one another at short intervals is at least three, but preferably in the range from three to ten, in particular four.

14. The device according to claim 7, wherein the transmitter makes it possible to generate the antenna supply in such a way that the time interval between successive series of bursts following one another at short intervals is at least 1 s, but preferably lies in the range from 1 s to 3 s, in particular at 2 s.

15. A computer program product, which causes a method according to claim 1 to be performed on a program-controlled device.
